(19) United States
(12) Patent Application Publication
(10) Pub. No.: US 2006/0151255 A1
(43) Pub. Date: Jul. 13, 2006

(54) Vertical reciprocating conveyor

(75) Inventor: Stephen M. Payne, Waukesha, WI (US)

Correspondence Address: MICHAEL BEST & FRIEDRICH, LLP, 100 E WISCONSIN AVENUE, MILWAUKEE, WI, 53202, US

(73) Assignee: Wildeck, Inc., Waukesha, WI (US)

(21) Appl. No.: 10/881,346

(22) Filed: Jun. 30, 2004

(51) Int. Cl. B66B 5/16

(52) U.S. Cl. 187/351

(57) ABSTRACT

A vertical reciprocating conveyor includes a frame and a carrier movable up and down with respect to the frame to elevate and lower articles supported by the carrier. The conveyor also includes a prime mover and at least one sprocket rotating in response to operation of the prime mover. At least one flexible support member extends across the carrier from one side to an opposite side, and engages the at least one sprocket such that the at least one flexible support member is collected and let out in response to the direction of rotation of the sprocket to raise and lower the carrier with respect to the frame. The conveyor also includes brakes on the opposite sides of the carrier. The brakes are biased to engage the frame to prevent the carrier from free falling. The brakes are held out of engagement with the frame by the at least one flexible support member, and are permitted to substantially simultaneously engage the frame on opposite sides of the carrier in response to slack forming in the flexible support member. The conveyor further includes a sensor for sensing slack in one of the flexible support members.

### BACKGROUND OF THE INVENTION

The invention relates to a vertical reciprocating conveyor.

### BRIEF DESCRIPTION OF THE INVENTION

The invention provides a vertical reciprocating conveyor that includes a frame and a carrier movable up and down with respect to the frame to elevate and lower articles supported by the carrier. The conveyor also includes a prime mover and at least one sprocket rotating in response to operation of the prime mover. At least one flexible support member extends across the carrier from one side to an opposite side, and engages the at least one sprocket such that the at least one flexible support member is collected and let out in response to the direction of rotation of the sprocket to raise and lower the carrier with respect to the frame. The conveyor also includes brakes on the opposite sides of the carrier. The brakes are biased to engage the frame to prevent the carrier from free falling. The brakes are held out of engagement with the frame by the at least one flexible support member, and are permitted to substantially simultaneously engage the frame on opposite sides of the carrier in response to slack forming in the flexible support member.

### BRIEF DESCRIPTION OF THE DRAWINGS

FIG. 1 is a perspective view of a vertical reciprocating conveyor embodying the present invention.

FIG. 2 is a perspective view of the carriage and a portion of the frame of the conveyor.

FIG. 3 is an enlarged perspective view of a prime mover portion of the conveyor.

FIG. 4 is an enlarged perspective view of a side portion of the conveyor.

FIG. 5 is a perspective view of a load yoke portion of the conveyor.

FIG. 6 is a perspective view of a brake assembly of the conveyor.

FIG. 7 is an exploded view of the brake assembly.

FIG. 8 is a side view of a portion of the conveyor showing the brake assembly in a disengaged condition.

FIG. 9 is a side view of a portion of the conveyor showing the brake assembly in an engaged condition.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

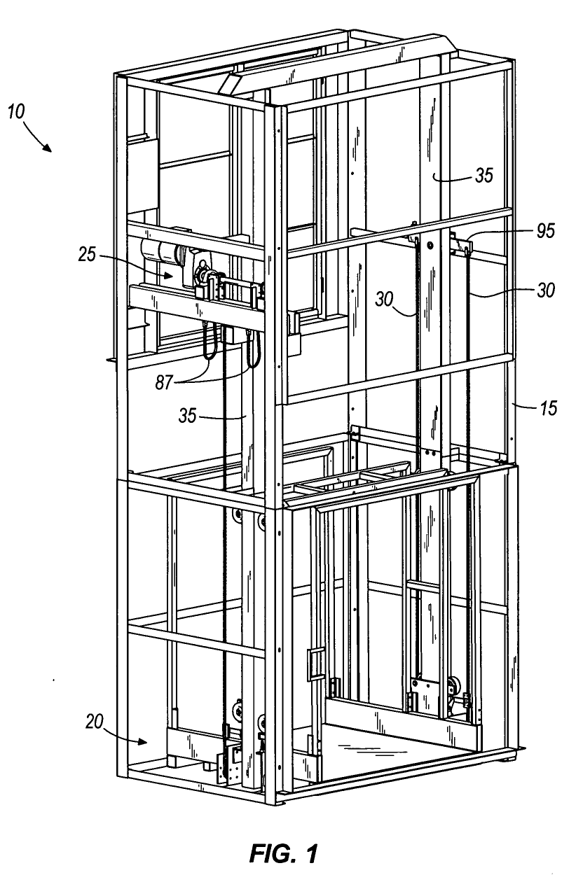

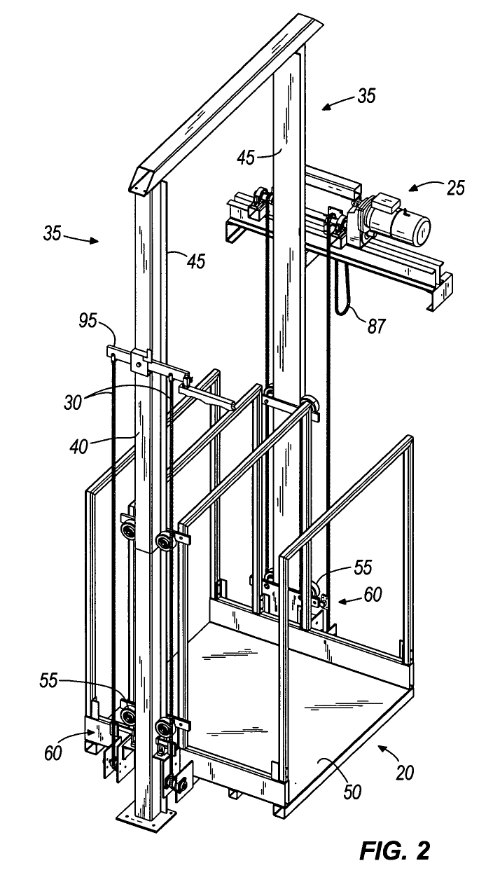

FIGS. 1 and 2 illustrate a vertical reciprocating conveyor (“VRC”) 10 that includes a frame 15 supporting a carriage 20. A prime mover assembly 25 is mounted to a side of the frame 15, and will be discussed in greater detail below. Flexible support members 30 are interconnected between the carriage 20 and the prime mover assembly 25 to enable the prime mover assembly 25 to raise and lower the carriage 20. As used herein, the term “flexible support members” means wire ropes, chains, roller chains, leaf chains, belts, or any other tension-bearing flexible member from which the carriage 20 may be suspended within the frame 15. In the illustrated embodiment, the flexible support members 30 are connected to an upper portion of one side of the frame 15, extend down along that side of the frame 15, extend under the carriage 20, and extend up the opposite side of the frame 15 to the prime mover assembly 25. This arrangement will be discussed in more detail below.

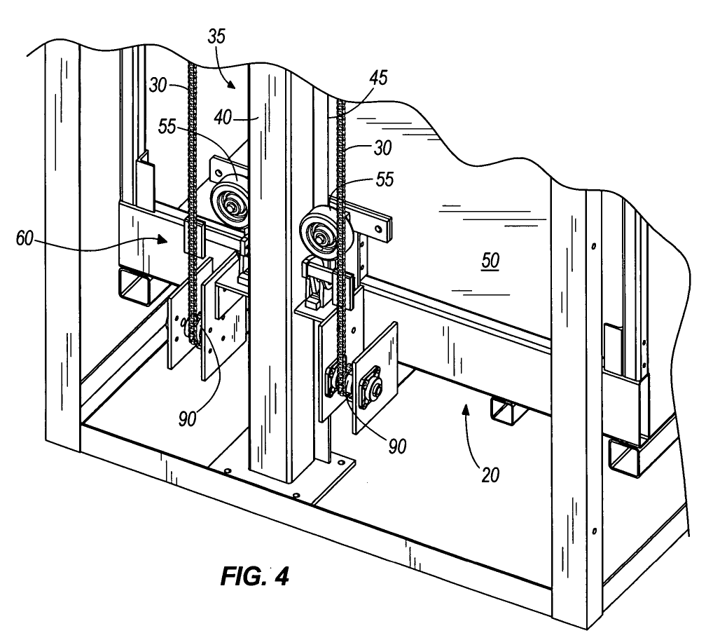

With particular reference to FIG. 2, the frame 15 includes a pair of vertical masts 35 upon which the carriage 20 rides. The masts 35 include a base portion 40 having side surfaces, and a flange 45 that is wider than the base portion 40 (see also FIG. 4). The carriage 20 includes a support surface 50 for supporting objects to be raised and lowered on the carrier 20, wheels 55 that roll along the side surfaces of the masts 35 to facilitate smooth movement of the carriage 20 relative to the masts 35, and brake assemblies 60 which engage the flanges 45 of the masts 35 to resist free-fall of the carriage 20 in the event of slack developing in one or more of the flexible support members 30. As used herein with respect to the flexible support members 30, the term “slack” means a loss of tension in the flexible support members 30 sufficient to permit the brake assemblies 60 to engage the flanges 45 of the masts 35. For example, and without limiting the foregoing, slack may arise due to a sudden jolt in the raising or lowering of the carriage 20 or due to the flexible support members 30 breaking or suddenly stretching.

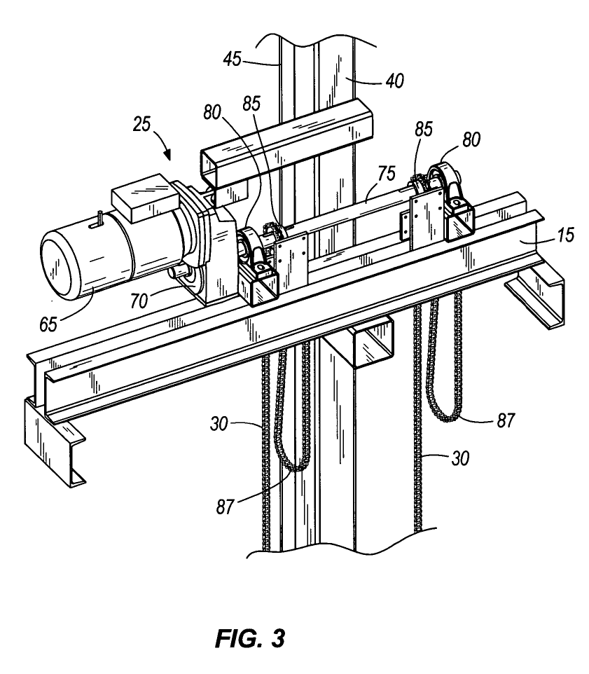

Turning now to FIG. 3, the illustrated prime mover assembly 25 includes a prime mover 65 and a gear box 70. The prime mover 65 may be, for example and without limitation, a motor or an engine. The prime mover 65 may be powered by substantially any source, such as electricity, gasoline, diesel, natural gas or other fuel, or hydraulic or pneumatic fluid, and the invention is not limited to any particular type of prime mover. The prime mover 65 is mounted to the side of the frame 15 (as opposed to mounting it on top of the frame), so that the frame 15 may extend substantially all the way to the ceiling of the building in which it is positioned. This arrangement permits objects to be raised substantially to the ceiling of the building to maximize the storage capacity from floor to ceiling of the building. The prime mover 65 includes an output shaft that engages and drives the gear box 70. The gear box 70 reduces the output speed of the output shaft with a relatively large gear that creates a mechanical advantage and increases the torque capacity of the prime mover 65. The increased torque capacity permits the prime mover 65 to lift heavier loads than would be possible with a direct coupling to the prime mover 65 itself.

A spindle 75 is supported by a pair of bearings 80, and is coupled to the gear box 70 for rotation in response to operation of the prime mover assembly 25. The spindle 75 has mounted thereto a pair of sprockets 85 that are fixed for rotation with the spindle 75 with splines, keys, fasteners, or another suitable method. As used herein, the term “sprockets” includes the illustrated sprockets commonly used with chains, sheaves commonly used to drive belts, drums, pulleys, and any other apparatus that can be rotated to take up or let out a flexible support member. The flexible support members 30 extend across the sprockets such that, depending on the direction of rotation of the spindle 75, the sprockets 85 take up or let out the flexible support member 30 to raise or lower, respectively, the carriage 20.

In the illustrated embodiment of the invention, each flexible support member 30 forms a loop 87 that hangs down from the sprockets 85. The loop 87 increases in size when the carriage 20 is raised and decreases in size when the carriage is lowered. In alternative embodiments the flexible support member 30 may be wrapped around a drum or other device, in which case there would be no loop 87 hanging down.

With reference to FIG. 4, each side of the carriage 20 has mounted thereto a pair of sprockets 90 for the respective flexible support members 30. The embodiment illustrated has the sprockets 90 at the bottom of the carriage 20 such that the flexible support members 30 extend underneath the carriage 20 and cradle the carriage 20. In other embodiments, the flexible support members 30 extend across the top of the carriage 20 or across other parts of the carriage 20 to cradle it. The cradling action of the flexible support members 30 self-corrects the orientation of the carriage 20 to reduce the likelihood of one side of the carriage 20 rising above the other.

The prime mover assembly 25 and the spindle 75 should be positioned so that the top of the carriage 20 is about even with the top of the frame 15 when the sprockets 90 are even with or slightly below the sprockets 85. Thus, in the illustrated embodiment, the prime mover assembly 25 and spindle 75 are lower than the top of the frame 15 by a distance that is slightly less than the height of the carriage 20. In alternative embodiments, the frame 15 may be constructed with an open top such that the top of the carriage 20 may actually extend above the top of the frame 15. In such constructions, the prime mover assembly 25 and spindle 75 may be positioned even higher when an underslung flexible support member 30 arrangement (as in the illustrated embodiment) is used. If the flexible support members 30 extend across the top of the carriage 20, as may be the case in other embodiments, the prime mover assembly 25 and spindle 75 should be positioned very near the top of the frame 15 to maximize the vertical travel of the carriage 20 in the frame 15.

Because there are two flexible support members 30 in the illustrated embodiment, each flexible support member 30 carries half of the weight of the carriage 20 and its cargo. Because each flexible support member 30 extends vertically along both sides of the carriage 20, each vertical portion of each flexible support member 30 carries half of the weight born by that flexible support member 30. In other words, each vertical portion of the flexible support members 30 carries a quarter of the weight of the carriage and its cargo. This load-sharing arrangement permits the use of lower rated flexible support members 30 and smaller sprockets 85, 90. The arrangement also creates a mechanical advantage for the prime mover assembly 25 because the ratio of flexible support member 30 gathered or let out by the sprockets 85 to carriage 20 vertical displacement is 2:1. The overall result of the arrangement permits the use of a smaller prime mover 65 (compared to an arrangement in which one or two flexible support members 30 raised and lowered the carriage in a 1:1 ratio), and permits smaller gears to be employed in the gearbox 70. The reduction in size of the flexible support members 30, sprockets 85, 90, prime mover 65, and gear box 70 may reduce the cost of the VRC.

Turning now to FIG. 5, a load yoke 95 is mounted to the mast 35 on the opposite side from the prime mover assembly 25. The load yoke 95 is pivotally mounted with respect to the mast 35 by way of a pin 100. The pin 100 is off-center with respect to the span of the load yoke 95 so that the load yoke 95 will tip to one side when under the influence of gravity alone. Alternatively or in addition to the offset pin arrangement, a weight may be affixed to one end of the load yoke 95 to ensure that the load yoke 95 will tip when under the influence of gravity alone. Two links 105 are mounted to the load yoke 95 at equidistant points on either side of the pin 100. The flexible support members 30 are connected to the links 105.

The tension in the flexible support members 30 applies equal and offsetting moment forces to the load yoke 95 and keeps the load yoke 95 substantially level. If there is slack in one of the flexible support members 30 the moment force applied through the other flexible support member 30 causes the load yoke 95 to tip. If slack develops in both flexible support members 30, the yoke 95 will tip of its own accord under the influence of gravity alone. A tip sensor 110 is mounted to the frame 15 adjacent the load yoke 95, senses when the load yoke 95 tips, and sounds an alarm that indicates slack in one or both of the flexible support members 30.

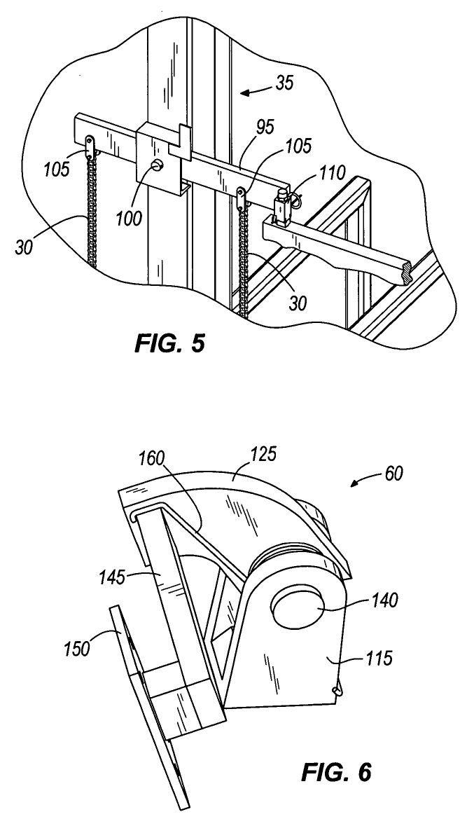

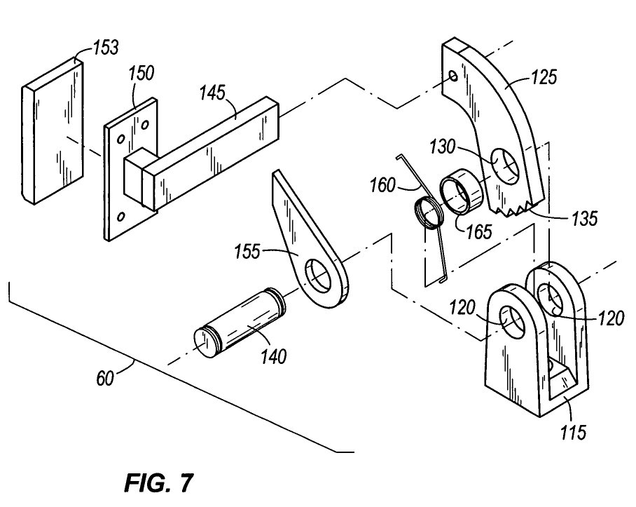

FIGS. 6-9 illustrate one of the brake assemblies 60. Each brake assembly 60 include a base 115 having a pair of upright portions having aligned holes 120. The base 115 is affixed to the carriage 20. A cam 125 also has a hole 130 that is placed into alignment with the holes 120 in the upright portions of the base 115. The cam 125 has a toothed end 135 for engaging the flange 45 of the mast. A shaft 140 extends through the holes 120, 130 such that the cam 125 is supported by the shaft 140 for pivotal movement with respect to the base 115. A supporting bar 145 extends from the cam 125 and supports a brake plate 150. The brake plate 150 includes an engaging surface, which in the illustrated embodiment is a wear surface 153 attached to the brake plate. The wear surface 153 is preferably constructed of a low-friction material. In alternative constructions, the engaging surface may include rollers or other friction-reducing components to facilitate low friction sliding of the flexible support members across the face of the brake plate 150.

A support link 155 is pivotally mounted to the shaft 140 and is affixed to the supporting bar 145 to provide additional support to the brake plate 150. A torsion spring 160 is wrapped around the shaft 140 and is anchored at one end to the base 115 and at the other end to the supporting bar 145. A spacer 165 may be employed between the upright portions of the base 115 to reduce or prevent sliding of the cam 125 and torsion spring 160 on the shaft 140.

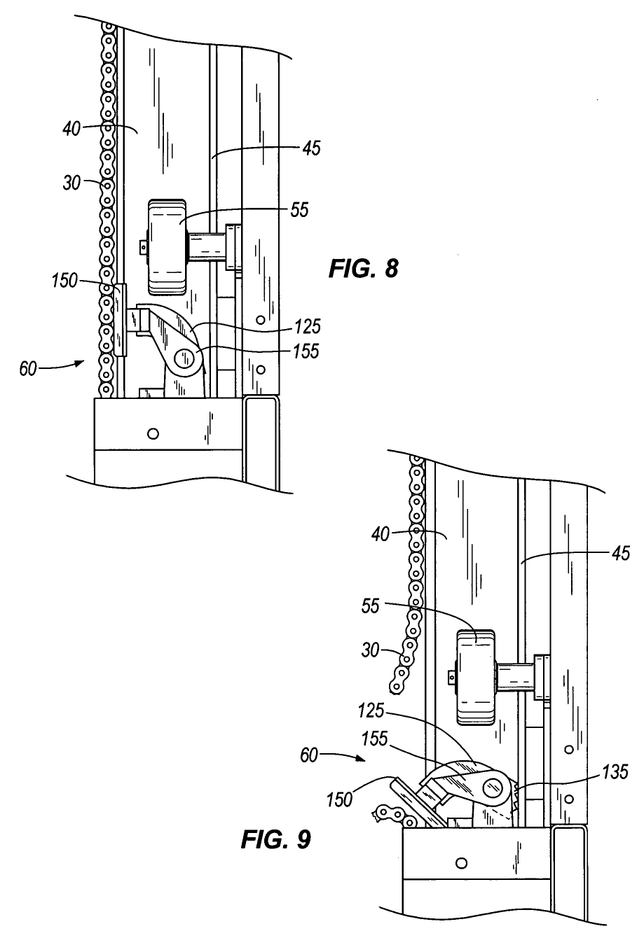

The brake assemblies 60 are mounted to the carriage 20 to position the brake plates 150 over the carriage sprockets 90 with the flexible support members 30 extending across the face of the brake plates 150. During ordinary operation of the VRC 10 (as illustrated in FIG. 8), the torsion springs 160 bias the brake plates 150 into engagement with the flexible support members 30 and the cams 125 of the brake assemblies 60 are held out of engagement with the flanges 45 by the flexible support members 30. In the event slack develops in one of the flexible support members 30 (as illustrated in FIG. 9), the cams 125 of the two brake assemblies 60 engaging that flexible support member 30 (i.e., the brake assemblies on opposite sides of the carriage 20) will both be released substantially simultaneously and the torsion springs 160 will cause the toothed ends 135 of the cams 125 to substantially simultaneously engage the flanges 45 of the respective flanges 45 to brake the carriage 20.

The substantially simultaneous engagement of the brakes 60 on opposite sides of the carriage 20 helps to keep the carriage 20 level, even when one or both of the flexible support members 30 breaks. Since the brakes 60 on opposite sides engage substantially simultaneously, they share the load of the carriage 20 and its cargo. It is therefore believed that the illustrated arrangement of brake assemblies 60 reduces damage to the frame 15 and carriage 20 when slack develops in one or both of the flexible support members 30. Also, because two brake assemblies 60 engage substantially simultaneously and share the load, smaller brake assemblies 60 may be used when compared to a constructions relying on a single, larger brake assembly.

It should be noted that, although the illustrated embodiment discloses cam style brake assemblies 60, other types of brake assemblies may be used in the present invention as well. For example, the carriage 20 may include an angled surface, together with the flange 45, defines a wedge-shaped space opening downwardly. A roller or gear may be positioned in a relatively wide portion of the wedge-shaped space during normal operation of the VRC 10 such that the roller does not engage the flange 45 and carriage 20 simultaneously. The brake assembly may further include a mechanism for moving the roller into a relatively narrow portion of the wedge-shaped space where it is pinched between the flange 45 and a portion of the carriage 20 so that the carriage 20 cannot move downwardly with respect to the frame 15. The mechanism for moving the roller into the narrow portion of the wedge-shaped space may include, for example, a spring biasing the roller toward the narrow portion and a wheel or other low-friction member engaging the flexible support member 30 and resisting the biasing force of the spring while there is tension in the flexible support member 30.

1. A vertical reciprocating conveyor comprising:
a frame;
a carrier movable up and down with respect to the frame to elevate and lower articles supported by the carrier;
a prime mover;
at least one sprocket rotating in response to operation of the prime mover;
at least one flexible support member extending across the carrier from one side to an opposite side, the at least one flexible support member engaging the at least one sprocket such that the at least one flexible support member is collected and let out in response to the direction of rotation of the sprocket to raise and lower the carrier with respect to the frame; and
brakes on the opposite sides of the carrier and biased to engage the frame to prevent the carrier from free falling;
wherein the brakes are held out of engagement with the frame by the at least one flexible support member, and wherein the brakes are permitted to substantially simultaneously engage the frame on opposite sides of the carrier in response to slack forming in the flexible support member.

2. The conveyor of claim 1, wherein the flexible support member extends across and underneath the carrier to cradle the carrier.

3. The conveyor of claim 1, wherein the flexible support member extends across the top of the carrier to cradle the carrier.

4. The conveyor of claim 1, wherein the prime mover is positioned such that substantially all of the prime mover is below the top of the frame.

5. The conveyor of claim 1, wherein each of the brakes includes a base, an cam, and a biasing member; wherein the base is mounted to the carrier, the cam includes a frame-engaging surface and a flexible support member engaging surface, and the biasing member biases the cam for movement with respect to the base toward engagement of the frame with the frame-engaging surface; and wherein the flexible support member is in engagement with the flexible support member engaging surface and resists the biasing force of the biasing member while there is no slack in the flexible support member such that the frame-engaging surface is prevented from engaging the frame in the absence of slack in the flexible support member.

6. The conveyor of claim 5, wherein the flexible support member engaging surface includes a low-friction surface to facilitate sliding of the flexible support member thereacross.

7. The conveyor of claim 5, wherein the flexible support member engaging surface includes a roller to facilitate low-friction movement of the flexible support member across the flexible support member engaging surface.

8. The conveyor of claim 1, wherein the at least one flexible support member is affixed to the frame near the top of a first side of the frame and extends downwardly along the first side of the frame, wherein the at least one flexible support member extends across the carriage from the first side a second side that is opposite the first side, wherein the flexible support member extends upwardly along the second side of the frame, and wherein the prime mover and at least one sprocket are mounted on the second side of the frame.

9. The conveyor of claim 8, wherein the flexible support member extends underneath the carrier from the first side to the second side of the frame, such that the carrier is cradled and supported from underneath by the flexible support member.

10. A vertical reciprocating conveyor comprising:
a frame;
a prime mover;
a load yoke pivotally mounted to the frame about a pivot point and having first and second attachment points substantially equidistant from the pivot point on opposite sides of the pivot point;
first and second flexible support members interconnected with the load yoke at the respective first and second attachment points, the first and second flexible support members extending across the carrier and interconnected with the prime mover on the side of the frame opposite the load yoke; and
means for signaling slack in at least one of the first and second flexible support members in response to pivoting of the yoke;
wherein the flexible support members support substantially equal portions of the weight of the carrier such that the yoke is maintained in a neutral position during raising and lowering of the carrier; and
wherein, upon the occurrence of slack in one of the flexible support members, the force of the other suspension member tilts the load yoke and activates the means for signaling.

11. The conveyor of claim 10, wherein the load yoke includes a cross arm that includes the first and second attachment points, and wherein the cross arm is unbalanced on the pivot point such that the load yoke will pivot on the pivot point in the absence of offsetting forces applied by the flexible support members, such that the means for signaling is activated upon the simultaneous formation of slack in both flexible support members.

12. The conveyor of claim 10, wherein the flexible support member extends across and underneath the carrier to cradle the carrier.

13. The conveyor of claim 10, wherein the prime mover is mounted to the frame such that substantially all of the prime mover is below the top of the frame.

14. The conveyor of claim 10, further comprising two brakes on a first side of the carrier and two brakes on the opposite side of the carrier, wherein the brakes are biased toward engagement with the frame to resist vertical movement of the carrier, wherein the first and second flexible support members each engage a brake on each of the opposite sides to restrict the brakes from engaging the frame during normal operation of the conveyor, and wherein the two brakes engaged by each of the flexible support members will substantially simultaneously engage the frame on opposite sides of the carrier in the event slack develops in the corresponding flexible support member.

15. A method for operating a vertical reciprocating conveyor having a frame and a carrier movable up and down with respect to the frame, the method comprising the steps of:
interconnecting a flexible support member at one end to a first side of the frame;
positioning a prime mover at a second side of the frame opposite the first side such that substantially the entire prime mover is below the top of the frame;
extending the flexible support member across the carrier to the second side of the frame;
interconnecting the flexible support member to a sprocket;
rotating the sprocket in response to operation of the prime mover;
gathering and letting out the flexible support member with the sprocket in response to operation of the prime mover; and
moving the carrier up and down one unit for each two units of flexible support member gathered and let out, respectively, with the sprocket.

16. The method of claim 15, further comprising:
mounting first and second brakes on opposite sides of the carrier and biasing the brakes for engagement with the respective first and second sides of the frame;
resisting the biasing force on the brakes with the flexible support member to retain the brakes out of engagement with the frame;
permitting the first and second brakes to substantially simultaneously engage the respective first and second sides of the frame in response to slack developing the flexible support member; and
resisting, by way of the engagement of the brakes with the frame, downward movement of the carrier under the influence of gravity.
